(19) United States
(12) Patent Application Publication
(10) Pub. No.: US 2010/0195269 A1
(43) Pub. Date: Aug. 5, 2010

(54) HYBRID SUPERCAPACITOR USING SURFACE-OXIDIZED TRANSITION METAL NITRIDE AEROGEL

(75) Inventors: Hak-Kwan KIM, Hanam-si (KR); Seung-Hyun RA, Seongnam-si (KR); Jun-Hee BAE, Suwon-si (KR); Hyun-Chul JUNG, Yongin-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/537,009

(22) Filed: Aug. 6, 2009

(30) Foreign Application Priority Data
Feb. 3, 2009 (KR) 10-2009-0008581

(51) Int. Cl. H01G 9/155

(52) U.S. Cl. 361/502; 29/25.03

(57) ABSTRACT

It discloses a hybrid supercapacitor including a carbon aerogel cathode and a surface-oxidized transition metal nitride aerogel anode which is able to increase energy density and power density with increase of overall cell potential and at the same time lower internal resistance of the electrode and equivalent series resistance by using a monolithic electrode with no use of current collector and binder.

### CROSS-REFERENCE TO RELATED APPLICATIONS

This application claims the benefit of Korean Patent Application No. 10-2009-0008581 filed on Feb. 3, 2009, with the Korea Intellectual Property Office, the contents of which are incorporated here by reference in their entirety.

### BACKGROUND

1. Technical Field

It relates to a hybrid supercapacitor including a carbon aerogel cathode and a surface-oxidized transition metal nitride aerogel anode.

2. Description of the Related Art

Higher value-added businesses which collect and use various and useful information in real time by employing IT equipments receives attentions and stable energy supply for securing reliability of such systems becomes an important factor in the information-oriented society. These IT equipments and electrical devices include electric circuit boards and each circuit board has a capacitor which stores an electric charge and releases it when required and thus stabilizes energy flow in the circuit. This capacitor has a very short charge/discharge time, a long lifetime and a high power density but generally a very low energy density. This disadvantage of low energy density causes many limitations on its use as an energy storage device.

However, electrochemical capacitors, supercapacitors or ultracapacitors, which have started to be commercialized in Japan, Russia, USA, etc. since 1995, are under development in all countries of the world to provide higher energy density as next generation energy storage devices along with secondary batteries.

A supercapacitor can be broadly classified into 3 categories depending on the electrode and the mechanism: (1) an electric double layer capacitor (EDLC) which employs activated carbon as an electrode and is based on an electric double layer electric charge absorption mechanism; (2) a metal oxide electrode pseudocapacitor (or redox capacitor) which employs a transition metal oxide and a conductive polymer as an electrode material and is based on a pseudo-capacitance mechanism; and (3) a hybrid capacitor which combines the features of both electrochemical and electrolytic capacitors. Among them, the EDL-type supercapacitor using activated carbons is currently used the most.

The supercapacitor is composed of electrode, electrolyte, current collector, and separator and is based on the electrochemical mechanism which stores energy through absorption of electrolyte ions on the electrode surface by migrating along with the electric field when voltages are applied on the both ends of a unit cell electrode. Since the specific capacitance is proportional to the specific surface area, the supercapacitor improves energy (storage) density through the use of an activated carbon electrode, which is a porous material. An electrode is manufactured by preparing slurry including a carbon electrode material, a carbon conductive material and a polymer binder and coating the slurry on a current collector. Here, it is important to improve adhesiveness to the current collector and reduce contact resistance at the same time and further lower internal contact resistance between activated carbons by changing a ratio or kind of the binder, the conductive material and the electrode material.

When a pseudocapacitor using a metal oxide electrode material is used, the transition metal oxide exhibits higher capacity and higher power density compared to activated carbons. Recently, it has been reported that amorphous hydrate electrodes exhibit much higher specific capacitance.

However, even though it provides higher electric capacitance, its manufacturing cost is more than twice higher, manufacturing is more difficult and equivalent series resistance is increased, compared with the EDLC.

Thus, studies on hybrid capacitors, which employ an asymmetric electrode by combining the best features of the EDLC and the pseudocapacitor, are increasing to improve actuation voltages and energy density. However, even though the hybrid capacitor improves electric capacitance and energy density, it is not generalized yet and due to its nonlinarity, its properties such as charge/discharge properties are not ideal.

### SUMMARY

It provides a hybrid supercapacitor which is able to increase energy density and power density with increase of overall cell potential and lower internal resistance of the electrode and equivalent series resistance by using a monolithic electrode without using a current collector and a binder.

According to an aspect of embodiments, there is provided a hybrid supercapacitor including a carbon aerogel cathode; and a surface-oxidized transition metal nitride aerogel anode.

The carbon aerogel cathode may have a pore size distribution of a mesopore size of 20 nm or higher. The carbon aerogel of the carbon aerogel cathode may be prepared by a method including: preparing a resorcinol-formaldehyde sol solution; immersing the sol solution into carbon paper and drying; and pyrolizing the dried paper.

The transition metal nitride of the surface-oxidized transition metal nitride aerogel anode may be chosen from vanadium nitride (VN), titanium nitride (TiN), molybdenum nitride (MO₂N), tungsten nitride (TuN) and niobium nitride (NbN).

The transition metal nitride aerogel of the surface-oxidized transition metal nitride aerogel anode may be prepared by a method including: obtaining transition metal oxide aerogel from alkoxide of the transition metal by performing a sol-gel process; and pyrolizing the transition metal oxide aerogel under ammonia gas to convert to the transition metal nitride aerogel.

The surface oxidation of the surface-oxidized transition metal nitride aerogel anode may be performed by pyrolizing the transition metal nitride aerogel under an inert gas containing oxygen.

According to another aspect of embodiments, there is provided a method for manufacturing a hybrid supercapacitor including: preparing a carbon aerogel cathode; preparing a surface-oxidized transition metal nitride aerogel anode; and preparing a hybrid capacitor by employing the cathode and the anode.

The hybrid supercapacitor may control parameters not to form micropores having a size of not contributing substantial capacitance during the manufacturing process of the aerogel cathode and anode and further improve capacitance by optimizing an effective contact area between an electrolyte solution and an electrode since it is a monolith type which is not necessary to use any binder.

The hybrid supercapacitor may resolve a contact resistance problem which can be caused in the boundary between an electrode and a current collector since it is a monolith type which is not necessary to use any current collector.

Therefore, the hybrid supercapacitor may increase energy and power density with increase of over all cell potential which is advantages of the hybrid-type supercapacitor and at the same time minimize the electrode internal resistance and the equivalent series resistance (ESR) since it is a monolith type which is not necessary to use any current collector and binder

### BRIEF DESCRIPTION OF THE DRAWINGS

FIG. 1 is a schematic view of a monolithic hybrid supercapacitor according to an embodiment.

FIG. 2 is a SEM picture (low magnification) of activated carbon powders.

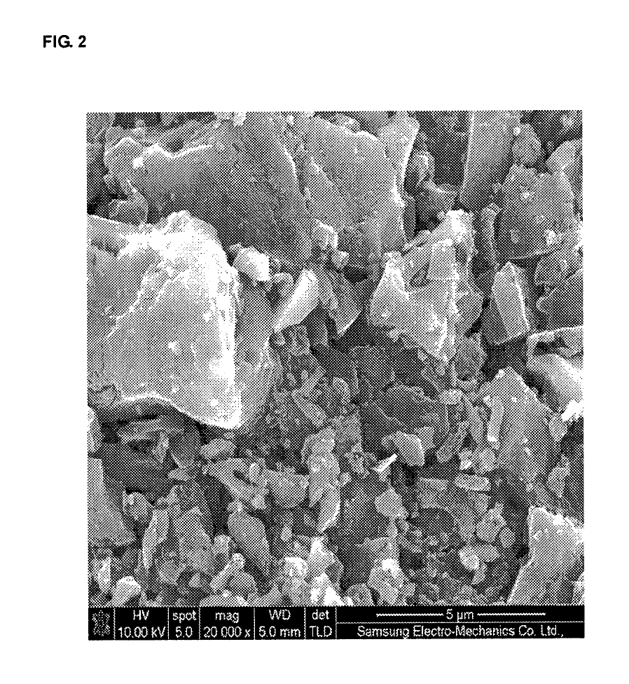

FIG. 3 is a SEM picture (high magnification) of activated carbon powders.

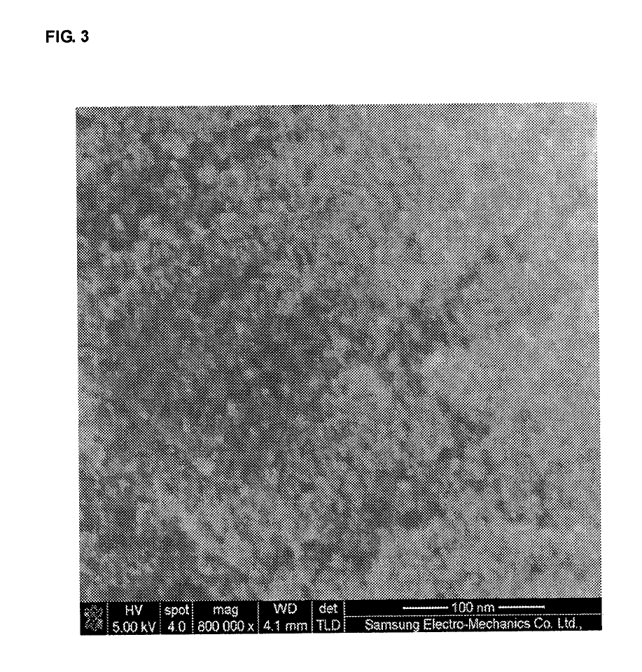

FIG. 4 is a SEM picture (low magnification, inside picture is high magnification) of the surface of a monolithic VN aerogel according to an embodiment.

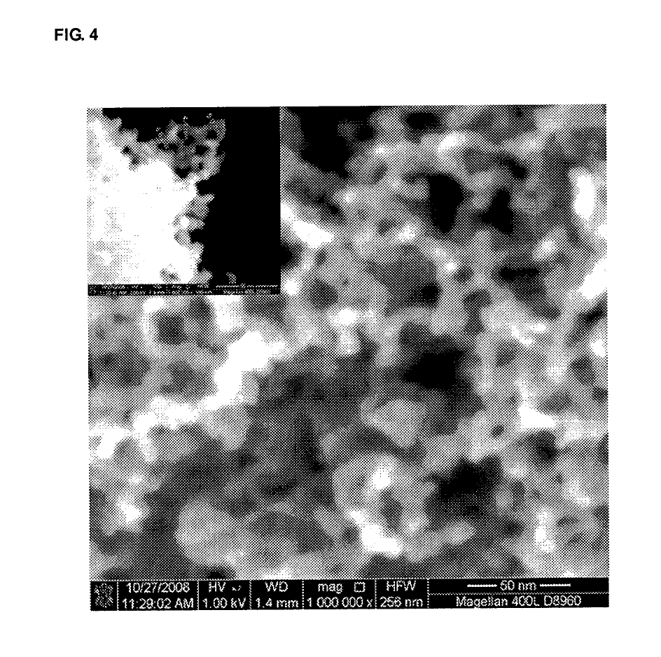

FIG. 5 is a SEM picture (high magnification) of a surface-oxidized monolithic VN aerogel according to an embodiment.

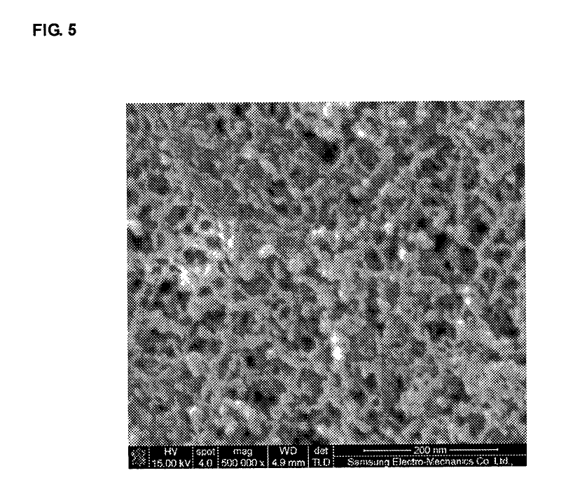

FIG. 6 is a CV (cyclic voltammetry) graph illustrating the charge-discharge result of a hybrid supercapacitor prepared in Example.

FIG. 7 is a CV (cyclic voltammetry) graph illustrating the charge-discharge result of a hybrid supercapacitor prepared in Comparison Example.

Hereinafter, preferred embodiments will be described in detail of the hybrid supercapacitor.

The hybrid supercapacitor may include a carbon aerogel cathode; and a surface-oxidized transition metal nitride aerogel anode and further include a separator and an electrolyte.

Carbon Aerogel Cathode

A material having a high specific area may be used as an electrode material to improve the electric capacitance of a supercapacitor since the capacitance is proportional to the area of an electrode. Further, the supercapacitor may have superior electronic conductivity, electrochemical inactivity, formability, processability and the like and porous carbon materials having such properties have been generally used. Examples of the porous carbon material may include activated carbons, activated carbon fibers, amorphous carbons, carbon aerogels, carbon composites, carbon nanotubes and the like.

However, even though the activated carbons have high specific area, effective pores of the activated carbon is only about 20% because most pores are micropores of which diameter is about 20 nm or less and which cannot server as an electrode. Since the electrode is prepared from slurry which is formed by mixing binder, carbon conducting material and solvent, etc. an actual effective contact area between an electrode and an electrolyte is decreased. There are further drawbacks such as uneven electric capacitance and contact resistance between an electrode and a current collector.

The hybrid supercapacitor may employ a monolith carbon aerogel cathode.

The term “monolith type or monolithic” may be an integrally formed electrode which thus does not require use of a binder and a current collector.

The term “aerogel” may be a solid-state material derived from gel in which the liquid component of the gel is replaced with gas and have a net-work structure with a high porosity. The aerogel may be used as a monolithic electrode since it is formed integrally and thus does not require the use of binder and current collector.

According to an embodiment, the carbon aerogel of the monolith carbon aerogel cathode may be prepared by preparing a porous polymer using an organic material through a sol-gel process and pyrolizing the porous polymer.

The sol-gel process may include preparing a solution by dissolving an organic monomer, an aldehyde and a surfactant, etc in a solvent such as water, stirring the solution, polymerizing the solution at an appropriate temperature, and removing the solvent by drying and isolating, etc.

In the sol-gel process, the organic material may be an organic monomer including hydroxyl or amine groups of which example may include resorcinol, phenol, melamine, biphenol and sucrose, etc. and examples of the aldehyde may include formaldehyde and acetaldehyde, etc.

The pyrolysis may be performed at a temperature of 700-1050° C. under an inert atmosphere such as nitrogen gas.

For example, in order to prepare carbon aerogel by the sol-gel process and the pyrolysis, resorcinol (R), formaldehyde (F) and sodium carbonate, which is a basic catalyst, are condensed at an aqueous phase, in various catalyst ratios (R/C). The sol solution from the condensation at an aqueous phase may be immersed into carbon paper and the result may be fixed between glass plates and dried in a closed container to prevent evaporation of the RF carbon paper. The carbon paper-immersed RF aerogel composite may be obtained after the remained water is substituted with acetone or the like and then pyrolized at a high temperature (700-1050° C.) under N₂ to provide monolith carbon aerogel. The monolith carbon aerogel is CO₂ activated by injecting CO₂ into the monolith carbon aerogel at a high temperature to increase effective pores.

A size of carbon aerogel may be controlled by adjusting parameters during the manufacturing process.

When a mole ratio of the organic monomer is increased while fixing concentration parameters of other components, size of agglomerated clusters is increased. Since spaces between clusters become pores, when the size of clusters increases with increase of the organic monomer mole ratio, the size of pores between clusters also increases. On the other hand, when a mole ratio of a surfactant is increased while fixing concentration parameters of other components, size of agglomerated clusters is decreased and thus size of pores becomes decreased. Thus, the pore size and ratio may be controlled by adjusting such parameters.

The monolith carbon aerogel prepared by the above method may be used as a cathode material by cutting it in an electrode size and since the carbon aerogel has excellent conductivity, it may be produced into an electrode by connecting lead wires without using a current collector.

Even though the specific area of the carbon aerogel prepared by the above method is similar to that of conventional activated carbon (700-1000 m²/g), it has much more effective pores of which diameter is 20 nm or higher and much less contact area with an electrolyte since any binder is not used. Further, there is little risk of reduction of energy density due to the contact resistance because an electrode is prepared without using a current collector.

Surface-Oxidized Transition Metal Nitride Aerogel Anode

A hybrid supercapacitor may use a surface-oxidized monolith transition metal nitride aerogel anode.

A transition metal nitride has superior electric conductivity compared with a transition metal oxide. Thus, when the surface of the transition metal oxide is oxidized, it may provide an electrode which has characteristics of a pseudocapacitor in full and significantly improved electric conductivity.

According to an embodiment, a transition metal nitride which can be used for the surface-oxidized monolith transition metal nitride aerogel anode may be vanadium nitride (VN), titanium nitride (TiN), molybdenum nitride (Mo2N), tungsten nitride (TuN) or niobium nitride (NbN), etc., preferably vanadium nitride.

The transition metal nitride aerogel may be prepared directly by employing the sol-gel process using a transition metal precursor as a starting material.

The transition metal nitride aerogel may be prepared indirectly by preparing a transition metal oxide aerogel by the sol-gel process using a transition metal precursor as a starting material and converting to a transition metal nitride aerogel using ammonia.

The transition metal precursor may be an alkoxide of a transition metal such as vanadium n-propoxide, vanadium pentoxide, niobium ethoxide and the like.

The prepared transition metal nitride aerogel may be surface-oxidized to the corresponding surface-oxidized transition metal nitride aerogel which can be used as an electrode. The surface oxidation may be performed by a heat treatment under inert gas atmosphere containing a small amount of oxygen.

A pore size of the surface-oxidized transition metal nitride aerogel may be controlled by adjusting parameters during the manufacturing process.

The surface-oxidized monolith transition metal nitride aerogel prepared by the above method may be used as an anode material by cutting into an electrode size and since the surface-oxidized transition metal nitride aerogel has excellent conductivity, it may be produced into an electrode by connecting lead wires without using a current collector.

The electrode has far superior electric conductivity compared with transition metal oxides and still keeps characteristics of pseudo-capacitances

Separator

A separator prevents internal short circuits between cathode and anode electrode and immerses an electrolyte. A separator material suitable for the hybrid supercapacitor described above may be polyethylene nonwoven fabrics, polypropylene nonwoven fabrics, polyester nonwoven fabrics, polyacrylonitrile porous separators, poly(vinylidene fluoride)hexafluoropropane copolymer porous separators, cellulose porous separators, kraft papers, rayon fabrics or the like and be any separator which is generally used for batteries and capacitors.

Electrolyte

An electrolyte chargeable to the hybrid supercapacitor described above may be aqueous electrolytes, non-aqueous electrolytes, solid electrolytes or the like.

The aqueous electrolyte may be 5 to 100 wt % of aqueous sulfuric acid solution, 0.5 to 20 M of aqueous potassium hydroxide solution, or neutral electrolytes such as aqueous potassium chloride solution, aqueous sodium chloride solution, aqueous potassium nitride solution, aqueous potassium sulfate solution and the like but may not be limited thereto.

The non-aqueous electrolyte may be an organic electrolyte in which a salt composed of a cation such as tetraalkylammonium (e.g., tetraethylammounium or tetramethylammonium), lithium ion, or potassium ion, etc. and an anion such as tetrafluoroborate, perchlorate, hexafluorophosphate, bis(trifluoromethane)sulfonylimide or trisfluoromethane sulfonylmethide, etc. is dissolved to be 0.5 to 3 M in a nonprotonic solvent, a solvent having a high dielectric constant (e.g., propylene carbonate or ethylene carbonate), or a solvent having a low viscosity (e.g., diethyl carbonate, dimethyl carbonate, ethylmethyl carbonate, dimethyl ether or diethyl ether).

Further, the electrolyte may be a gel-like polymer electrolyte, in which a polymer such as polyethylene oxide, polyacrylonitrile or the like is immersed in an electrolyte, or an inorganic electrolyte such as LiI, Li₃N or the like.

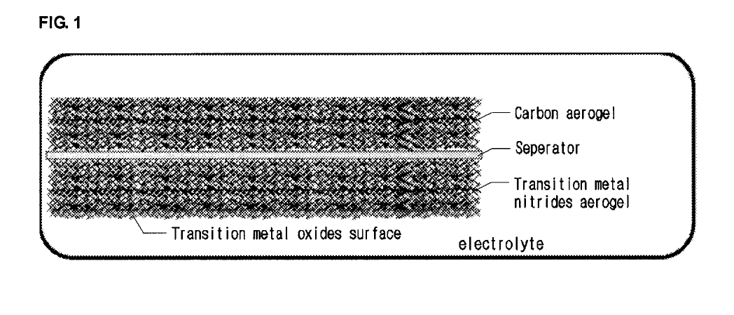

FIG. 1 illustrates a schematic view of a hybrid supercapacitor, including a monolith carbon aerogel cathode, a surface-oxidized monolith transition metal nitride aerogel anode, a separator separating the cathode and anode, and an electrolyte, according to an embodiment.

Hereinafter, although more detailed descriptions will be given by examples, those are only for explanation and there is no intention to limit the invention.

### EXAMPLE

### Preparation of Monolith Carbon Aerogel Cathode

Resorcinol (R), formaldehyde (F) and sodium carbonate, which is a basic catalyst, were condensed at an aqueous phase. After the obtained sol solution was immersed into carbon paper, it was fixed between glass plates and dried in a closed container to prevent evaporation of the RF carbon paper and then the remained water was substituted with acetone to provide a RF aerogel composite immersed into carbon paper. The RF aerogel composite immersed into carbon paper was carried for the pyrolysis at a high temperature of 700-1050° C. under N₂ to provide a monolith carbon aerogel. It was further treated for CO₂ activation in order to increase effective pores finally to provide a monolith carbon aerogel having 3-dimensional network structure.

The obtained monolith carbon aerogel was cut in an appropriate size and connected with copper wires to obtain a carbon aerogel cathode.

### Preparation of Surface-Oxidized Monolith Vanadium Nitride (VN) Aerogel Anode

A vanadium pentoxide gel was obtained from decavanadic acid prepared by ion exchange on a resin from ammonium metavanadate solution. High surface area vanadium oxide aerogel (V₂O₅,1.6H₂O) was obtained by the progressive removal of water by solvent exchange in supercritical conditions. Heat treatment under ammonia was performed on the vanadium oxide aerogel at a temperature of 450-900° C. to provide vanadium nitride aerogel. The vanadium nitride aerogel was further heat-treated under inert gas containing a small amount of oxygen to provide a surface-oxidized transition metal nitride aerogel.

The obtained surface-oxidized vanadium nitride aerogel was cut in an appropriate size and connected with copper wires to provide a surface-oxidized monolith vanadium nitride aerogel anode.

### Preparation of Hybrid Supercapacitor

A hybrid supercapacitor was prepared by employing a working electrode which used the monolith carbon aerogel electrode as a cathode and the surface-oxidized monolith vanadium nitride aerogel electrode as an anode and copper wires to connect the electrodes without using binders or current collectors. Aqueous solution of 1M H₂SO₄ was used as an electrolyte.

### COMPARISON EXAMPLE

### Preparation of Supercapacitor Using Carbon Aerogel Electrode as a Cathode and an Anode

Two of monolith carbon aerogel electrodes were prepared by the same method to prepare the carbon aerogel in Example and used as a cathode and an anode to prepare a supercapacitor.

### EXPERIMENTAL EXAMPLE

The hybrid supercapacitor (carbon aerogel cathode/surface-oxidized VN aerogel anode) prepared in Example and the supercapacitor (carbon aerogel cathode/carbon aerogel cathode) prepared in Comparison Example were each determined for electrochemical properties.

Platinum (Pt) and saturated calomel electrode (SCE) were used as a counter electrode and a reference electrode, respectively and an aqueous solution of 1M H₂SO₄ was used as an electrolyte.

Cyclic voltammetry was used to determine similar properties with 2-electrode cells.

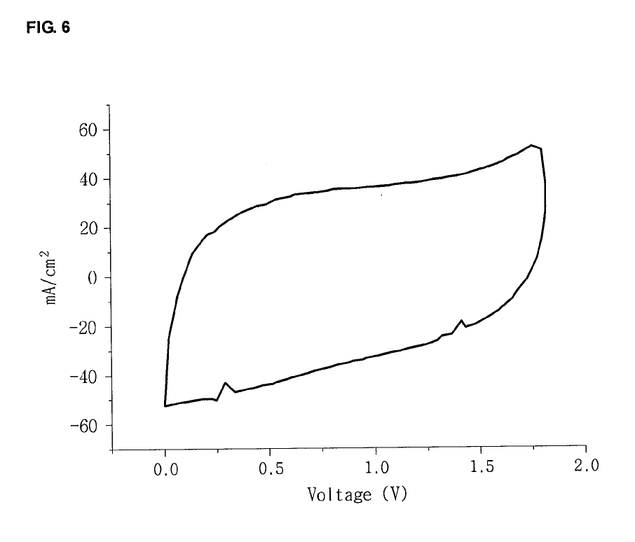

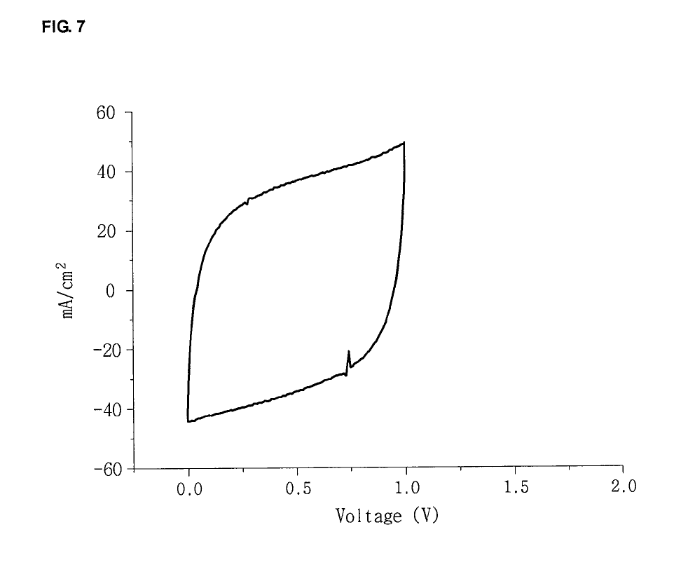

As shown in FIG. 6 (Example) and FIG. 7 (Comparison Example), both were a little distorted but typical CV shapes of similar rectangular and mirror image which exhibited fast reversible charge/discharge process.

It is noted that the hybrid supercapacitor prepared in Example (FIG. 6) shows a wider voltage range which provides improved energy density.

While it has been described with reference to particular embodiments, it is to be appreciated that various changes and modifications may be made by those skilled in the art without departing from the spirit and scope of the embodiment herein, as defined by the appended claims and their equivalents.

What is claimed is:

1. A hybrid supercapacitor comprising:
a carbon aerogel cathode; and
a surface-oxidized transition metal nitride aerogel anode.

2. The hybrid supercapacitor of claim 1, wherein the carbon aerogel cathode has a pore size distribution of a mesopore size of 20 nm or higher.

3. The hybrid supercapacitor of claim 1, wherein the carbon aerogel of the carbon aerogel cathode is prepared by a method comprising: preparing a resorcinol-formaldehyde sol solution; immersing the sol solution into carbon paper and drying; and pyrolizing the immersed-dried paper.

4. The hybrid supercapacitor of claim 1, wherein the transition metal nitride of the surface-oxidized transition metal nitride aerogel anode is selected from the group consisting of vanadium nitride (VN), titanium nitride (TiN), molybdenum nitride (MO₂N), tungsten nitride (TuN) and niobium nitride (NbN).

5. The hybrid supercapacitor of claim 1, wherein the transition metal nitride aerogel of the surface-oxidized transition metal nitride aerogel anode is prepared by a method comprising: obtaining transition metal oxide aerogel from alkoxide of the transition metal by using a sol-gel process; and pyrolizing the transition metal oxide aerogel under ammonia gas to convert to the transition metal nitride aerogel.

6. The hybrid supercapacitor of claim 1, wherein the surface oxidation of the surface-oxidized transition metal nitride aerogel anode is performed by pyrolizing the transition metal nitride aerogel under an inert gas containing oxygen.

7. A method for manufacturing a hybrid supercapacitor comprising:
preparing a carbon aerogel cathode;
preparing a surface-oxidized transition metal nitride aerogel anode; and
preparing a hybrid capacitor by employing the cathode and the anode.
